(19) United States
(12) Patent Application Publication
(10) Pub. No.: US 2012/0142842 A1
(43) Pub. Date: Jun. 7, 2012

(54) USE OF ALKALINE CARBONATE SALTS TO REDUCE THE DOSE OF ACRYLIC POLYMER IN A METHOD OF GRINDING CALCIUM CARBONATE IN WATER

(75) Inventors: Christian JACQUEMET, Lyon (FR); Olivier GUERRET, La Tour de Salvagny (FR)

(73) Assignee: COATEX S.A.S., Genay (FR)

(21) Appl. No.: 13/299,413

(22) Filed: Nov. 18, 2011

Related U.S. Application Data
(60) Provisional application No. 61/420,832, filed on Dec. 8, 2010.

(30) Foreign Application Priority Data
Dec. 2, 2010 (FR) 10 60012

(51) Int. Cl. C08K 3/26; C08L 35/00; C08L 41/00; C08L 99/00

(52) U.S. Cl. 524/425; 524/424

(57) ABSTRACT

The use of alkaline carbonate salts in a method of manufacturing an aqueous composition of calcium carbonate by grinding. These salts make it possible to reduce the quantity of grinding aid agents implemented, which are water-soluble homopolymers or copolymers of acrylic acid. These homopolymers or copolymers greatly contribute to increasing the carbon dioxide content of the atmosphere, and are derived from raw materials that come from a fossil fuel: by limiting their quantity, both the environment and our natural resources are preserved.

### REFERENCE TO PRIOR APPLICATIONS

This application claims priority to U.S. provisional application Ser. No. 61/420,832, filed Dec. 8, 2010; and to French patent application 10 60012, filed Dec. 2, 2010, both incorporated herein by reference.

### FIELD OF THE INVENTION

The present invention relates to a method of manufacturing an aqueous suspension of calcium carbonate through grinding in an aqueous medium by introducing one or more alkaline carbonate salts into said aqueous suspension of calcium carbonate. These salts make it possible to reduce the quantity of grinding aid agents implemented, which are typically homopolymers or copolymers of acrylic acid (sometimes termed an acrylic acid polymer herein), for an equivalent performance level in terms of the rheology and granulometry of the suspensions. These polyacrylates greatly contribute to increasing the carbon dioxide content of the atmosphere, and are derived from raw materials that come from a fossil fuel: by limiting their quantity, both the environment and our natural resources are preserved.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

In describing the background of the invention it is the intention of the inventors to prime the reader for a greater understanding of the invention. In doing so certain documents, patents, etc. are described. These documents speak for themselves, and although the discussion of their contents herein is believed to be accurate, any inadvertent mischaracterization does not constitute an admission.

The mineral industry is a major consumer of chemicals. These chemicals are used during the various conversion/modification/treatment steps that the mineral materials undergo. Thus, for a natural or synthetic calcium carbonate, numerous so-called “grinding” operations (reducing the grain size of the particles) in a dry or aqueous medium, or so-called “dispersion” operations (placing particles in suspension in a liquid), are performed.

These two actions are made easier by the respective implementation of grinding agents, whose role is to facilitate the mechanical action of particle attrition and fragmentation, and dispersing agents, whose function consists of keeping the viscosity of the suspension within acceptable ranges as the mineral materials are added to it. The present invention relates to grinding methods that implement grinding aid agents.

The art is particularly detailed when it comes to such additives. For many years, it has been known that water-soluble homopolymers of acrylic acid constitute effective agents for assisting with the dispersion or grinding of calcium carbonate in an aqueous medium. By way of reference, one may refer to documents FR 2 539 137, FR 2 683 536, FR 2 683 537, FR 2 683 538, FR 2 683 539 and FR 2 802 830.

For the same type of applications, it is also beneficial to copolymerize acrylic acid with another carboxylic monomer, such as itaconic, methacrylic, or sulfonic acid, such as 2-acrylamido-2-methyl-2-propane sulfonic acid or maleic anhydride, and/or with another ethylene-unsaturated monomer but without a carboxylic function, such as an acrylic ester: these variants are also described in the preceding documents.

It is also known that regulating the polymolecularity index of water-soluble polymers makes it possible to optimize some of their performance outcomes. This is described in the documents “Synthesis and Characterization of Poly(acrylic acid) Produced by RAFT Polymerization. Application as a Very Efficient Dispersant of CaCO3, Kaolin, and TiO2” (Macromolecules, 36(9), 3066-3077, 2003) and “Dispersion of calcite by poly(sodium acrylate) prepared by Reversible Addition-Fragmentation chain Transfer (RAFT) polymerization” (Polymer (2005), 46(19), 8565-8572). The checking of this polymolecularity index is particularly obtained using so-called “living” polymerization techniques, as illustrated in documents WO 02/070571 and WO 2005/095466. Patent FR 2 514 746, meanwhile, describes a so-called “fragmenting” method making it possible to regulate the polymolecularity index by selecting polymer chains with a given length, depending on the selected application for the agent in question.

It is also known that the choice of the specific water-soluble acrylic polymer's molecular weight may, in certain particular methods for manufacturing calcium carbonate in an aqueous medium, improve the efficiency of said method: patent EP 1 248 821 for example, highlights carboxylic polymers with a high molecular weight, in order to disperse a significant quantity of a calcium carbonate derived from a step of low-concentration grinding in the absence of polymers.

Independent of these different lines of improving the application properties of an acrylic acid-based dispersing agent or grinding agent (choosing a comonomer, a polymerization technique, regulating the molecular weight), it is known that the particular choice of certain neutralization agents leads to substantially improved application properties.

In this manner, document EP 0 100 948 shows the benefit of neutralization by implementing a combination of sodium and calcium ions. A generation of later patents (FR 2 683 538 and FR 2 683 539), meanwhile, highlights the pairing of magnesium/sodium ions. Finally, a most recent generation of patents (EP 1 347 834 and EP 1 347 835) which relies on partial neutralization (not all of the carboxylic sites are neutralized) based on the joint action of a monovalent agent (preferentially sodium) and at least one divalent agent (preferentially calcium or magnesium) is known.

Nonetheless, all of these solutions rely on the implementation of homopolymers and copolymers of acrylic acid, which are known to generate carbon dioxide, and to be derived from a raw material which is polypropylene, itself originating from petroleum, i.e. a fossil fuel. Minimizing their quantity in industrial methods such as the dispersion or grinding of calcium carbonate in an aqueous medium is currently a major issue for the chemical industry. This approach is in line with reducing the level of carbon dioxide as defined by the Kyoto protocol, and with limiting fossil fuels in our methods: more generally speaking, it is in line with the concepts of “green chemistry” and “sustainable development”.

### SUMMARY OF THE INVENTION

The inventors have developed a method for manufacturing an aqueous suspension of calcium carbonate by grinding in water with at least one water-soluble acrylic acid polymer (i.e., at least one water-soluble homopolymer and/or copolymer of acrylic acid), with the introduction of at least one alkaline carbonate salt into said suspension. Entirely advantageously, it has been shown that this successfully reduces the quantity of polyacrylate implemented, while preserving or improving a certain number of properties related to the rheology and granulometry of the suspension (see, e.g., the examples supporting the present Application).

### DETAILED DESCRIPTION OF THE PREFERRED EMBODIMENTS

In one embodiment the present invention relates to a method of manufacturing an aqueous suspension of calcium carbonate, comprising grinding calcium carbonate in water in the presence of a water-soluble acrylic acid polymer and an alkaline carbonate salt.

In a preferred embodiment the alkaline carbonate salt(s) is/are introduced during grinding in any form, including the form of the mixture with a polyacrylate and/or introduced during grinding at the same time as a polyacrylate. In the first situation, the aqueous formulations resulting from the mixing of the salt and the polyacrylate constitute another embodiment of the present invention, as does their manufacturing method. Additionally, the very use of these alkaline salts according to the invention constitutes another embodiment of the present invention, as an additive that makes it possible to reduce the quantity of grinding aid agents that are otherwise implemented.

It is known that during the grinding operation, the concentration of calcium ions increases in the aqueous phase, owing to the fragmentation of individual calcium carbonate particles. However, it is well known that these calcium ions constitute, along with polyacrylates, complex ion-polymer species, which are insoluble to varying extents in an aqueous phase. Without wishing to be bound to any theory, the inventors believe that adding an alkaline carbonate salt into water modifies both the solubility of the polyacrylates in an aqueous phase, as well as the surface properties of the calcium carbonate particles: this encourages the adsorption of the acrylic polymers onto the surface of the mineral particles. As the grinding mechanisms are encouraged by a good adsorption of polyacrylates onto the surface of the mineral particles, the efficiency of the grinding method is thereby improved.

It is believed that the alkaline carbonate salts implemented according to the invention have no direct action on the grinding of the calcium carbonate: they are not grinding aid agents within the meaning of this term as used at the beginning of this application. Additionally, these salts are believed not in any way to modify the characteristics of the carbonate obtained after grinding compared to a carbonate ground with the same grinding aid agent but without the salt (however, the dose of grinding aid agent can be decreased in order to obtain the same granulometric and rheological characteristics for the final suspension). These characteristics mainly included the usual optical properties of a calcium carbonate, such as its whiteness and its opacity.

Thus, one object of the invention is a method of manufacturing an aqueous suspension of calcium carbonate by grinding calcium carbonate in water along with at least one water-soluble homopolymer and/or copolymer of acrylic acid, with the introduction of at least one alkaline carbonate salt.

In a first variant, this method is characterized in that said salt is introduced entirely in the form of a mixture in water with at least one water-soluble homopolymer and/or copolymer of acrylic acid, potentially with at least one other additive chosen from among a biocide and/or a defoamer. In concrete terms, said mixture is carried out before the operation of grinding the calcium carbonate. This mixture is then introduced into the corresponding grinder.

In a second variant, this method is characterized in that said salt is introduced entirely and distinctly from the water-soluble homopolymer and/or copolymer of acrylic acid, into the aqueous suspension of calcium carbonate, before and/or during and/or after the introduction of said acrylic polymer. In this situation, the polyacrylate and the alkaline carbonate salts are introduced directly and separately into the aqueous suspension of calcium carbonate to be ground.

In the third variant, this method is characterized in that said salt is introduced:
partly in the form of a mixture in water with at least one water-soluble homopolymer and/or copolymer of acrylic acid, and with at least one other additive chosen from among a biocide and/or a defoamer,
and partly by directly introducing into the aqueous suspension of calcium carbonate, potentially by separately adding at least one water-soluble homopolymer and/or copolymer of acrylic acid into said suspension.

This variant corresponds to a combination of the two previous ones.

Generally speaking the method is further preferably characterized in that the alkaline salt is chosen from among salts of sodium, potassium, and lithium, and mixtures thereof, and more preferably from among salts of sodium, potassium, and mixtures thereof (as lithium is a relatively expensive compound).

Generally speaking, the method is further preferably characterized in that the water-soluble homopolymer and copolymer of acrylic acid exhibit a molecular weight of between 3000 g/mol and 15,000 g/mol, and more preferably between 4000 g/mol and 10,000 g/mol. This molecular weight is determined, throughout the present Application, by the method described in the portion reserved for the examples.

The method is further preferably characterized in that the water-soluble homopolymer and copolymer of acrylic acid are fully or partially neutralized, and more preferably fully neutralized, by a neutralization agent chosen from among sodium and potassium hydroxides; calcium and magnesium oxides and hydroxide; ammonium hydroxide; and mixtures thereof, and more preferably by sodium hydroxide.

The method is further preferably characterized in that the water-soluble copolymer of acrylic acid is a water-soluble copolymer of acrylic acid with another monomer chosen from between methacrylic, crotonic, isocrotonic, cinnamic, maleic, or itaconic acids, acrylamido-2-methyl-2-propane sulfonic acid, and mixtures thereof.

The method is further preferably characterized in that the water-soluble homopolymer and copolymer of acrylic acid are obtained by methods of radical polymerization in solution, in a direct or inverse emulsion, in a suspension or precipitation in appropriate solvents, in the presence of catalytic systems and transfer agents, or by processes of controlled radical polymerization, and preferentially by nitroxide-mediated or cobaloxime-mediated polymerization (NMP), by atom transfer radical polymerization (ATRP), or by sulphurated derivative-mediated radical polymerization, said derivatives by chosen from among carbamates, dithioesters or trithiocarbonates (RAFT) or xanthates.

The method is further preferably characterized in that the water-soluble homopolymer and copolymer of acrylic acid are, before or after their neutralization, treated and separated into multiple phases, using static or dynamic methods, by one or more polar solvents that more preferably belong to the group made up by methanol, ethanol, propanol, isopropanol, butanols, acetone, tetrahydrofuran, or mixtures thereof.

Another object of the present invention is the use of at least one alkaline carbonate salt in a method of manufacturing an aqueous suspension of calcium carbonate by grinding in water with at least one water-soluble homopolymer and/or copolymer of acrylic acid, having the function of reducing the quantity of the acrylic polymer that is implemented. The expression “acrylic acid polymer” refers to the homopolymer and/or copolymer described above. The “quantity of the acrylic acid polymer” designates the quantity of dry polymer involved, in relation to the dry weight of the calcium carbonate that is implemented. This quantity is reduced, in relation to the same quantity of polymer being used, but without alkaline carbonate salts, without altering the viscosity and granulometry of the resulting suspension.

Another object of the present invention is an aqueous composition comprising water, at least one water-soluble homopolymer and/or copolymer of acrylic acid, and at least one alkaline carbonate salt.

This aqueous composition may also contain at least one other additive chosen from among a biocide and/or a defoamer.

This aqueous composition is further preferably characterized in that it contains:
5% to 50%, more preferably 30% to 50% by dry weight of a homopolymer and/or a water-soluble copolymer of acrylic acid,
1% to 30% by dry weight of at least one alkaline carbonate salt,
0% to 1% by dry weight of at least one other additive chosen from among a biocide, a defoamer, and mixtures thereof
   in relation to its total weight.

Generally speaking, this aqueous composition is further preferably characterized in that the alkaline salt is chosen from among salts of sodium, potassium, and lithium, and mixtures thereof, and more preferably from among salts of sodium, potassium, and mixtures thereof.

This aqueous composition is further preferably characterized in that the water-soluble homopolymer and copolymer of acrylic acid exhibit a molecular weight of between 3,000 g/mol and 15,000 g/mol, and more preferably between 4,000 g/mol and 10,000 g/mol.

This aqueous composition is further preferably characterized in that the water-soluble homopolymer and copolymer of acrylic acid are fully or partially neutralized, and more preferably fully neutralize, via neutralization agent chosen from among sodium and potassium hydroxides; calcium and magnesium oxides and hydroxide; ammonium hydroxide; and mixtures thereof, and more preferably by sodium hydroxide.

This aqueous composition is further preferably characterized in that the water-soluble copolymer of acrylic acid is a water-soluble copolymer of acrylic acid with another monomer chosen from between methacrylic, crotonic, isocrotonic, cinnamic, maleic, or itaconic acids, acrylamido-2-methyl-2-propane sulfonic acid, and mixtures thereof.

This aqueous composition is further preferably characterized in that the water-soluble homopolymer and copolymer of acrylic acid are obtained by methods of radical polymerization in solution, in a direct or inverse emulsion, in a suspension or precipitation in appropriate solvents, in the presence of catalytic systems and transfer agents, or by processes of controlled radical polymerization, and preferentially by nitroxide-mediated or cobaloxime-mediated polymerization (NMP), by atom transfer radical polymerization (ATRP), or by sulphurated derivative-mediated radical polymerization, said derivatives by chosen from among carbamates, dithioesters or trithiocarbonates (RAFT) or xanthates.

This aqueous composition is further preferably characterized in that the water-soluble homopolymer and copolymer of acrylic acid are, before or after their neutralization, treated and separated into multiple phases, using static or dynamic methods, by one or more polar solvents that more preferably belong to the group made up by methanol, ethanol, propanol, isopropanol, butanols, acetone, tetrahydrofuran, or mixtures thereof.

Another object of the present invention is a method of manufacturing an aqueous composition, by introducing under agitation at a temperature of between 10° C. and 90° C., and more preferably between 30° C. and 60° C., at least one carbonate salt in the form of a powder in an aqueous solution of at least one homopolymer and/or of the water-soluble copolymer of acrylic acid having an initial solids content of between 10% and 60%, more preferably between 25% and 50%, and optionally by adding at least one other additive chosen from among a biocide and/or a defoamer.

The following examples will make it possible to better understand the invention, though without limiting its scope.

### EXAMPLES

Throughout the present Application, the granulometric characteristics related to calcium carbonate are determined from a Sedigraph™ 5100 device, sold by the company MICROMERITICS™.

The molecular weights are determined by Steric Exclusion Chromatography, using the following method.

A test sample of the polymer solution corresponding to 90 mg of dry matter is added into a 10 mL flask. The mobile phase is added, plus 0.04% DMF, up to a total mass of 10 g.

The composition of this mobile phase is as follows: NaHCO3: 0.05 mol/L, NaNO3: 0.1 mol/L, triethanolamine: 0.02 mol/L, NaN3 0.03% by mass.

The SEC system is made up of a Waters™ 510 isocratic pump, whose flow rate is set to 0.8 mL/min, a Waters 717+ autosampler, an oven containing a Guard Column Ultrahydrogel Waters™ precolumn, followed by a “Ultrahydrogel Waters™” column 30 cm long and 7.8 mm in internal diameter.

Detection is ensured by a Waters™ 410 type differential refractometer. The oven is brought to a temperature of 60° C., and the refractometer is brought to a temperature of 45° C.

The SEC is calibrated with a series of sodium polyacrylate standards supplied by Polymer Standard Service whose molecular weight at the tip of the peak is between 2,000 and 1.10⁶ g/mol, and whose polymolecularity index is between 1.4 and 1.7, as well as with a sodium polyacrylate whose molecular weight is equal to 5,600 g/mole and whose polymolecularity index is equal to 2.4.

The calibration curve is linear and takes into account the correction obtained using the flow marker (DMF).

The chromatogram is acquired and processed using the software PSS WinGPC Scientific v 4.02. The resulting chromatogram is integrated into the area corresponding to molecular weights greater than 65 g/mol.

### Example 1

This example illustrates the manufacturing of different mixtures of polyacrylates with alkaline calcium salts.

### Tests #1a to 1c

These tests implement the introduction of sodium carbonate into an aqueous solution of a homopolymer of acrylic acid that has been fully neutralized by sodium hydroxide and whose molecular weight is equal to 5500 g/mol. The sodium carbonate is introduced in the form of a powder into a reactor under agitation containing the polymer solution at a 41% concentration and a temperature of 50° C. The agitation and mixing phase is carried out until a clear, homogenous mixture is obtained. After the sodium carbonate has been fully dissolved, a sufficient quantity of water is introduced into the reactor in order to obtain a mixture whose concentration of solids content is 43%. The masses involved are given in table 1.

TABLE 1

| | Test no. | | | | | |
|---|---|---|---|---|---|---|
| | 1a | | 1b | | 1c | |
| PANa to 41% | 1415.9 | kg | 1368.7 | kg | 1337.2 | kg |
| Na₂CO₃ | 64.5 | kg | 83.9 | kg | 96.8 | kg |
| water | 19.6 | kg | 47.4 | kg | 66 | kg |

### Tests #2a and 2b

These tests implement the introduction of potassium carbonate into an aqueous solution of the same polyacrylic acid as for tests #1a to 1c. These tests are carried out in the same reactor as before, to which is joined an inline disperser. The polymer solution at a temperature of 20° C. circulates in the loop and passes through a dispersion chamber constituted by a rotor/stator system where high shear effects exist. A near-vacuum is created within the dispersion chamber. This vacuum sucks in the potassium carbonate powder that is well-mixed with the sodium polyacrylate solution. After the powder has been fully incorporated, the inline mixer is left to operate until the potassium carbonate has fully dissolved and a clear solution has been obtained. A sufficient quantity of water is finally introducing the reactor in order to obtain a mixture whose concentration of solid content is 43%. The masses involved are given in table 2.

TABLE 2

| | Test no. | | | |
|---|---|---|---|---|
| | 2a | | 2b | |
| PANa to 41% | 1415.9 | kg | 1258.5 | kg |
| K₂CO₃ | 64.5 | kg | 129 | kg |
| water | 19.6 | kg | 112.5 | kg |

### Example 2

This example illustrates the use of various polyacrylate/alkaline carbonate salt mixtures, in a method of grinding calcium carbonate in an aqueous medium.

Thus, in practice, the operation of grinding the mineral substance to be refined consists of grinding the mineral substance with a grinding body into very fine particles in an aqueous medium containing the grinding aid agent.

The grinding operation itself is carried out with the help of a KDL-Pilot A DYNO®-MILL device containing the grinding body, whose granulometry is advantageously between 0.20 and 4 millimeters. The grinding body generally comes in the form of particles of materials as diverse as silicon oxide, aluminum oxide, zirconium oxide, or mixtures thereof, as well as very hard synthetic resins, steels, or other substances. An example composition of such grinding bodies is given by the patent FR 2 303 681, which describes grinding elements that are formed of (by weight) 30% to 70% zirconium oxide, 0.1% to 5% aluminum oxide, and 5 to 20% silicon oxide.

The grinding body is preferentially used in such quantity that the ratio by weight between that grinding material and the mineral substance to be ground is at least 2/1, with this ratio being preferentially between the limits 3/1 and 5/1.

It begins by preparing an aqueous suspension of calcium carbonate to be ground, by introducing, during agitation, water, the mixture containing the dispersing agent and an additive, and then calcium carbonate. After 20 minutes of agitation, this suspension is introduced into the grinding chamber containing the grinding body. This grinding body is set in motion by means of rotating blades. In successive passes, the mineral suspension is subjected to the mechanical action of crushing and attrition.

The grinding chamber is equipped with double cooling insulation in order to keep the grinding temperature within a range of temperatures between 60 and 80° C., as well as a pressure indicator.

The non-stop grinding operation is left to continue until a 0.5 bar rise in pressure is observed within the grinder. The ground-up suspension is then sampled and characterized.

For each of the tests that is carried out, the Brookfield™ viscosity is determined at 100 revolutions per minute and 25° C., at the output of the grinder (μ100 in mPa·s): this data makes it possible to quantify the fluidity of the obtained suspension.

It is then also determined, with a Sedigraph™ 5100 from the company Micromeritics™, the proportion by weight of particles whose diameter is less than 2 μm (%<2 en %): In this way, the fineness of the carbonate grains obtained after grinding is evaluated.

The corresponding results appear in table 3.

In all the tests, the ppm designate mg of dry additive in relation to the dry weight of the calcium carbonate expressed in kg.

### Test No. 1

This test illustrates the prior art, and implements 2250 ppm of a water-soluble homopolymer of acrylic acid fully neutralized by sodium hydroxide, whose molecular weight is equal to 5,500 g/mol.

### Test No. 2

This test illustrates the invention, and implements 2500 ppm of the mixture manufactured according to test 1a of example 1. Therefore, 2250 ppm of a water-soluble homopolymer of acrylic acid fully neutralized by sodium hydroxide, whose molecular weight is equal to 5,500 g/mol, and 250 ppm of sodium carbonate, are implemented here.

### Test No. 3

This test illustrates the invention, and implements 2500 ppm of the mixture manufactured according to test 1c of example 1. Therefore, 2125 ppm of a water-soluble homopolymer of acrylic acid fully neutralized by sodium hydroxide, whose molecular weight is equal to 5,500 g/mol, and 375 ppm of sodium carbonate, are implemented here.

### Test No. 4

This test illustrates the invention, and implements 2500 ppm of the mixture manufactured according to test 2a of example 1. Therefore, 2250 ppm of a water-soluble homopolymer of acrylic acid fully neutralized by sodium hydroxide, whose molecular weight is equal to 5,500 g/mol, and 250 ppm of sodium carbonate, are implemented here.

### Test No. 5

This test illustrates the invention, and implements 2500 ppm of a mixture of a water-soluble homopolymer of acrylic acid fully neutralized by sodium hydroxide, whose molecular weight is equal to 5,500 g/mol (2125 ppm), as well as potassium carbonate (375 ppm). This mixture was prepared according to the procedure in example 1.

### Test No. 6

This test illustrates a domain outside the invention, and implements a mixture of the acrylic polymer (2250 ppm) of test #1 and sodium silicate (250 ppm). This mixture was prepared in the same way as the mixture implemented in test #2.

### Test No. 7

This test illustrates a domain outside the invention, and implements a mixture of the acrylic polymer (2250 ppm) of test #1 and sodium gluconate (250 ppm). This mixture was prepared in the same way as the mixture implemented in test #2.

### Test No. 8

This test illustrates a domain outside the invention, and implements a mixture of the acrylic polymer (2250 ppm) of test #1 and urea (250 ppm). This mixture was prepared in the same way as the mixture implemented in test #2.

### Test No. 9

This test illustrates a domain outside the invention, and implements a mixture of the acrylic polymer (2250 ppm) of test #1 and glucose (250 ppm). This mixture was prepared in the same way as the mixture implemented in test #2.

### Test No. 10

This test illustrates a domain outside the invention, and implements a mixture of the acrylic polymer (2250 ppm) of test #1 and glycerol (250 ppm). This mixture was prepared in the same way as the mixture implemented in test #2.

### Test No. 11

This test illustrates a domain outside the invention, and implements a mixture of the acrylic polymer (2250 ppm) of test #1 and sodium acetate (250 ppm). This mixture was prepared in the same way as the mixture implemented in test #2.

### Test No. 12

This test illustrates a domain outside the invention, and implements a mixture of the acrylic polymer (2125 ppm) of test #1 and sodium silicate (375 ppm). This mixture was prepared in the same way as the mixture implemented in test #3.

### Test No. 13

This test illustrates a domain outside the invention, and implements a mixture of the acrylic polymer (2125 ppm) of test #1 and glucose (375 ppm). This mixture was prepared in the same way as the mixture implemented in test #3.

TABLE 3

| | Test no. | | | | |
|---|---|---|---|---|---|
| | 1 | 2 | 3 | 4 | 5 |
| PA/IN/OI | PA | IN | IN | IN | IN |
| GAA (ppm) | 2250 | 2250 | 2125 | 2250 | 2125 |
| Add (ppm) | 0 | 250 | 375 | 250 | 375 |
| μ100 (mPa · s) | 160 | 124 | 138 | 151 | 157 |
| % <2 (%) | 59.3 | 62.0 | 58.8 | 62.4 | 59.1 |
| | Test no. | | | | |
| | 6 | 7 | 8 | 9 | 10 |
| PA/IN/OI | OI | OI | OI | CH | OI |
| GAA (ppm) | 2250 | 2250 | 2250 | 2250 | 2250 |
| Add (ppm) | 250 | 250 | 250 | 250 | 250 |
| μ100 (mPa · s) | 132 | 133 | 109 | 126 | 112 |
| % <2 (%) | 60.2 | 58.2 | 58.7 | 59.9 | 57.6 |

| | Test no. | | |
|---|---|---|---|
| | 11 | 12 | 13 |
| PA/IN/OI | OI | OI | OI |
| GAA (ppm) | 2250 | 2125 | 2125 |
| Add (ppm) | 250 | 375 | 375 |
| μ100 (mPa · s) | 101 | 175 | 160 |
| % <2 (%) | 54.9 | 57.2 | 56.8 |

PA/IN/OI: Prior art/invention/outside invention
GAA (ppm): acrylic grinding aid agent (quantity in ppm)
Add (ppm): additive potentially used with the grinding aid agent (quantity in ppm)

By comparing test #1 according to the prior art with tests #2 and #4 according to the invention (same dose of acrylic polymer), the benefit of implementing sodium carbonate or potassium carbonate is demonstrated: the proportion of particles whose diameter is less than 2 μm is increased, while the viscosity at the output of the grinder is substantially reduced. The result is therefore a more fluid aqueous suspension with finer particles.

None of the tests outside of the invention (#6 to 11) that implement the same quantity of additives as for tests #2 and 4 (i.e. 250 ppm) make it possible to obtain a comparable degree of fineness: at best 60.2% by weight of particles with a diameter less than 2 μm is obtained; this percentage is always at least equal to 62% in tests #2 and 4.

Finally, if the tests of the invention #3 and 5 that implement 2125 ppm of dispersing agent for 375 ppm of alkaline carbonate salt are compared with the tests outside the invention #12 and 13 that implement the same doses of grinding aid agents and an additive outside the invention, which is sodium silicate and glucose (additives chosen based on the performance obtained at 250 ppm in tests #6 and 9), the superiority of the performance outcomes obtained within the invention is observed.

### Example 3

This example illustrates the use of various polyacrylate/alkaline carbonate salt mixtures, in a method of grinding calcium carbonate in an aqueous medium.

This example starts with three of the aqueous suspensions obtained during example 2 (according to tests #1, 2, and 4) whose fineness is thought to be improved by continuing grinding in the presence of a homopolymer of acrylic acid, in which half of the carboxylic sites are neutralized by sodium hydroxide and the other half by calcium hydroxide, and whose molecular weight is equal to 5500 g/mol. The corresponding tests are denoted 1a, 2a, and 4a.

Grinding is continued until a suspension of calcium carbonate is obtained in which 80% by weight of the particles exhibit a diameter less than 1 μm.

Next, the Brookfield™ viscosity, measured at 100 revolutions per minute and 25° C., at the output of the grinder (μ100 by mPa·s), as well as the request for acrylic grinding aid agent implemented in the course of that second step of grinding (GAA in ppm). The corresponding results appear in table 4.

TABLE 4

| | Test no. | | |
|---|---|---|---|
| | 1a | 2a | 4a |
| PA/IN | PA | IN | IN |
| GAA (ppm) | 7750 | 7350 | 7230 |
| μ100 (mPa · s) | 400 | 270 | 260 |

Not only does the invention successfully reduce the demand for dispersing agent during this second step of grinding, but more fluid aqueous suspensions are achieved as well. This demonstrates the benefit of implementing alkaline carbonate salts in combination with acrylic polymers.

### Example 4

This example illustrates the separate introduction of acrylic polymer and salts in a calcium carbonate grinding method in an aqueous medium.

It therefore starts by creating an aqueous suspension of calcium carbonate by successively introducing, in water, an additive that is a sodium carbonate (invention) or a sodium sulfate (outside the invention) or a sodium chloride (outside the invention), or a salt of a grinding agent which is a partially neutralized homopolymer of acrylic acid (90% by molar weight of its carboxylic sites are neutralized by sodium hydroxide) whose molecular mass is equal to 5500 g/mol, then the calcium carbonate to be ground up.

Grinding was then carried out using the same protocol as the one described in example 2, except that the grinding is continued until a suspension is obtained that has a content by dry weight of calcium carbonate equal to 75% of its total weight.

### Test No. 14

This test illustrates the prior art, and implements 2250 ppm of the aforementioned acrylic polymer.

### Test No. 15

This test illustrates the invention, and implements 2250 ppm of the aforementioned acrylic polymer, and 250 ppm of sodium carbonate.

### Test No. 16

This test illustrates a domain outside the invention, and implements 2250 ppm of the aforementioned acrylic polymer, and 250 ppm of sodium sulfate.

### Test No. 17

This test illustrates a domain outside the invention, and implements 2250 ppm of the aforementioned acrylic polymer, and 250 ppm of sodium chloride.

The characteristics of the tests and suspensions obtained appear in Table 5.

TABLE 5

| | Test no. | | | |
|---|---|---|---|---|
| | 14 | 15 | 16 | 17 |
| PA/IN/OI | PA | IN | OI | OI |
| GAA (ppm) | 2250 | 2250 | 2250 | 2250 |
| Add (ppm) | 0 | 250 | 250 | 250 |
| μ100 (mPa · s) | 149 | 127 | 120 | 110 |
| % <2 (%) | 55.5 | 57.1 | 50.0 | 47.9 |

The sodium carbonate implemented according to test #15 makes it possible to increase the fineness of the ground-up calcium carbonate using the same dispersing agent as in test #14 describing the prior art; this is impossible with the other salts implemented according to tests #16 and 17.

The above written description of the invention provides a manner and process of making and using it such that any person skilled in this art is enabled to make and use the same, this enablement being provided in particular for the subject matter of the appended claims, which make up a part of the original description.

As used herein, the phrases “selected from the group consisting of,” “chosen from,” and the like include mixtures of the specified materials. Terms such as “contain(s)” and the like as used herein are open terms meaning ‘including at least’ unless otherwise specifically noted. The term “mentioned” notes exemplary embodiments, and is not limiting to certain species. As used herein the words “a” and “an” and the like carry the meaning of “one or more.”

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A method of manufacturing an aqueous suspension of calcium carbonate, comprising grinding calcium carbonate in water in the presence of a water-soluble acrylic acid polymer and an alkaline carbonate salt.

2. The method according to claim 1, wherein said salt is introduced into said grinding entirely in the form of a mixture comprising water, said salt, and said acrylic acid polymer, optionally further comprising at least one other additive chosen from a biocide and a defoamer.

3. The method according to claim 1, wherein said salt is introduced entirely and distinctly from the acrylic acid polymer during said grinding, before and/or during and/or after the introduction of said acrylic polymer.

4. The method according to claim 1, wherein said salt is introduced during said grinding:
partly in the form of a mixture comprising water, said salt, and said acrylic acid polymer, and further comprising at least one other additive chosen from a biocide and a defoamer, and
partly by directly introducing said salt.

5. The method according to claim 1, wherein the alkaline salt is selected from the group consisting of salts of sodium, potassium, and mixtures thereof.

6. The method according to claim 1, wherein the water-soluble acrylic acid polymer has a molecular weight of 3000 g/mol-15,000 g/mol.

7. The method according to claim 1, wherein the water-soluble acrylic acid polymer is fully or partially neutralized by at least one neutralization agent selected from the group consisting of sodium hydroxide, potassium hydroxide, calcium oxide, calcium hydroxide, magnesium oxide, magnesium hydroxide, and ammonium hydroxide.

8. The method according to claim 1, wherein the water-soluble acrylic acid polymer is a copolymer of acrylic acid with another monomer chosen from methacrylic, crotonic, isocrotonic, cinnamic, maleic, and itaconic acids, acrylamido-2-methyl-2-propane sulfonic acid, and mixtures thereof.

9. The method according to claim 1, wherein the water-soluble acrylic acid polymer is prepared by a method of radical polymerization in solution, in a direct or inverse emulsion, in a suspension or precipitation in a solvent, in the presence of catalytic systems and transfer agents, or by a process of controlled radical polymerization.

10. The method according to claim 1, wherein the water-soluble acrylic acid polymer is treated and separated into multiple phases, using static or dynamic methods, by one or more polar solvents.

11. An aqueous composition comprising water, a water-soluble acrylic acid polymer, and an alkaline carbonate salt.

12. The aqueous composition according to claim 11, wherein said composition comprises, in relation to its total weight:
5% to 50% by dry weight of said water-soluble acrylic acid polymer,
1% to 30% by dry weight of said alkaline carbonate salt.

13. The aqueous composition according to claim 11, wherein the alkaline salt is a salt of sodium, potassium, or a mixture thereof.

14. The aqueous composition according to claim 11, wherein the water-soluble acrylic acid polymer has a molecular weight of 3,000 g/mol-15,000 g/mol.

15. The aqueous composition according to claim 11, wherein the water-soluble acrylic acid polymer is fully or partially neutralized.

16. The aqueous composition according to claim 15, wherein the water-soluble acrylic acid polymer is fully neutralized by a neutralization agent selected from the group consisting of sodium hydroxide, potassium hydroxide, calcium oxide, calcium hydroxide, magnesium oxide, magnesium hydroxide, and ammonium hydroxide.

17. The aqueous composition according to claim 11, wherein the water-soluble acrylic acid polymer is a copolymer of acrylic acid with another monomer chosen from methacrylic, crotonic, isocrotonic, cinnamic, maleic, and itaconic acids, acrylamido-2-methyl-2-propane sulfonic acid, and mixtures thereof.

18. The aqueous composition according to claim 11, wherein the water-soluble acrylic acid polymer is prepared by a method of radical polymerization in solution, in a direct or inverse emulsion, in a suspension or precipitation in a solvent, in the presence of catalytic systems and transfer agents, or by a process of controlled radical polymerization.

19. A method of manufacturing an aqueous composition comprising water, a water-soluble acrylic acid polymer, and an alkaline carbonate salt, comprising:
introducing said alkaline carbonate salt in the form of a powder into an aqueous solution of said water-soluble acrylic acid polymer having an initial solids content of between 10% and 60% under agitation at a temperature of between 10° C. and 90° C.
